(19) United States
(12) Patent Application Publication
(10) Pub. No.: US 2010/0157256 A1
(43) Pub. Date: Jun. 24, 2010

(54) IMAGE PROJECTION DEVICE AND REAR PROJECTION TYPE DISPLAY DEVICE

(76) Inventors: Tatsuo Itoh, Osaka (JP); Kazuhisa Yamamoto, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/993,773

(22) PCT Filed: Jun. 23, 2006
(86) PCT No.: PCT/JP2006/312664

§ 371 Date: Dec. 21, 2007

(30) Foreign Application Priority Data
Jun. 24, 2005 (JP) 2005-184299

(51) Int. Cl. G03B 21/28

(52) U.S. Cl. 353/78; 353/99

(57) ABSTRACT

An image projection device comprising an image projection means (101) for projecting an image by laser light by using a one-dimensional or two-dimensional spatial light modulation element, a first folding mirror (102) for initially folding the laser light emitted from the image projection means (101), and a second folding mirror (103) for reflecting the laser light emitted from the image projection means (101) to a screen (107) through the first folding mirror (102), wherein a distance between the second folding mirror (103) and the image projection means (101) is made larger than a distance L by which a light output power emitted from the projection lens of the image projection means (101) with a solid angle of 38.4/(L×L) is less than 1 mW. Therefore, even when a person observes the image projection device (100) from a position onto which an image is projected, the person is in an area where safety is ensured, thereby enhancing the safety.

### TECHNICAL FIELD

The present invention relates to an image projection device and a rear projection type display device for projecting an image using laser light.

### BACKGROUND ART

An image projection device and a rear projection type display device have been known as large-screen display devices. While a high-pressure mercury lamp has conventionally been used as a light source, development of an image projection device using laser lights of three primary colors has recently been progressed because of its excellent color reproducibility and low power consumption. On the other hand, laser light is monochromatic light, and light having a coherent wavefront. Therefore, when the laser light enters into human eye, it converges to a point on retina, and might damage the retina. Accordingly, products using lasers are classified according to International Standard IEC60825 or JIS C6802:2005 in Japan, and guidelines to be maintained by manufacturers and users are provided for each class to enhance the safety of the laser products. The JIS C6802:2005 provides a term “maximum permissive exposure” (hereinafter referred to as MPE) which indicates a level of laser irradiation that does not adversely affect a human body under normal environmental conditions, by using, as parameters, laser wavelength, size of light source, exposure time, tissue to be exposed to risk, laser pulse width, and the like. Further, the JIS C6802:2005 provides a term “nominal ocular hazard distance” which determines a distance by which laser radiant illuminance or laser radiant exposure on retina becomes equal to the MPE on retina. When a laser light source is observed under the conditions which determine the nominal ocular hazard distance, from a distance larger than the nominal ocular hazard distance, eyes are not damaged. In a rear-projection type display device using a laser light source, it is required that laser irradiation should be equal to or lower than the laser irradiation level of class 1 at a position where the laser is emitted from a screen. The class 1 is a class which ensures the safety even when observation is continued for 30000 seconds. On the other hand, although laser light is not usually observed in the casing of the rear-projection type display device, if the screen is broken and thereby the inside of the casing is observable, the risk of damage on the eyes increases, and therefore, it is considered to detect such breaking of the screen and block the laser light (refer to Patent Document 1). Further, in a case where laser light from an image projection device is projected on a screen and the laser light divergently reflected at the screen is observed, it might be dangerous to directly observe the laser light from the image projection device although the divergently-reflected light is safe. So, it is considered to detect entering of a person into the image projection area, and lower the laser light output (refer to Patent Document 2). Furthermore, it is considered to provide a shielding which prevents a person from entering into the laser irradiation space so that the person cannot directly see the laser light (Patent Document 3). Since laser products of class 2 are visible laser lights, and this is a class in which safety can be ensured by avoidance behaviors including blinking reflex when a human being sees bright light. Therefore, at worst, it is important to prevent observation of laser light within the class 2 nominal ocular hazard distance.

Patent Document 1: Japanese Patent Publication No. 3606377

Patent Document 2: Japanese Patent Publication No. 2994469

Patent Document 3: Japanese Published Patent Application No. 2005-31526

### DISCLOSURE OF THE INVENTION

### Problems to be Solved by the Invention

In the construction of Patent Document 1, since the laser light is blocked when breaking of the screen is detected, if malfunction of a breaking detection means or malfunction of a circuit for blocking the laser light occurs, the laser light remains to be emitted, resulting in a problem that a person can observe the laser light close to the image projection device. Further, in the construction of Patent Document 2, when a person enters into the image projection area, the laser light output is varied regardless of the distance from the laser light source, resulting in a problem that the brightness of the projected image excessively varies. Further, in the construction of Patent Document 3, when the laser light is linear light, a person cannot peek the laser light until it is reflected at the screen even when the person is apart from the image projection device. Therefore, the area from the image projection device to the screen must be shielded to prevent a person from entering in the area, resulting in a problem that the shielding object becomes an eyesore, and the device is increased in size.

The present invention is made to solve the above-described problems and has for its object to provide an image projection device and a rear projection type display device which provide additional safety measures as well as the conventional safety measures. Further, it is another object of the present invention to provide an image projection device and a rear projection type display device which detect entering of a person into an area where laser light is dangerous to human eyes, and control laser light output.

### Measures to Solve the Problems

In order to solve the above-mentioned problems, according to Claim 1 of the present invention, there is provided an image projection device comprising: an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element; and n pieces of folding mirrors including an n-th folding mirror (n: an integer not less than 1) for reflecting the laser light emitted from the image projection unit toward the screen, said folding mirrors being provided between the image projection unit and the screen; wherein a distance between the n-th folding mirror and the image projection unit is larger than a class 2 nominal ocular hazard distance of the image projection unit.

According to Claim 2 of the present invention, in the image projection device defined in Claim 1, the class 2 nominal ocular hazard distance of the image projection unit is a distance L by which a light output power emitted from the projection lens with a solid angle of 38.4/(L×L) is 1 mW.

According to Claim 3 of the present invention, the image projection device defined in Claim 1 further includes a frame surrounding an optical path between the image projection unit and the n-th folding mirror.

According to Claim 4 of the present invention, in the image projection device defined in Claim 1, at least one of the n pieces of folding mirrors has a convex shape.

According to Claim 5 of the present invention, an image projection device comprising: an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element; and a restriction plate for restricting approach of a person to the laser light path, which is provided between the image projection unit and the screen; wherein a distance between the restriction plate and the image projection unit is larger than a class 2 nominal ocular hazard distance of the image projection unit.

According to Claim 6 of the present invention, in the image projection device defined in Claim 5, the class 2 nominal ocular hazard distance of the image projection unit is a distance L by which a light output power emitted from the projection lens with a solid angle of 38.4/(L×L) is 1 mW.

According to Claim 7 of the present invention, there is provided a rear projection type display device comprising: a transmission type screen; an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a plane opposite to an observation plane of the transmission type screen to form an image of the one-dimensional or two-dimensional spatial light modulation element; and at least two folding mirrors including a first folding mirror for folding the laser light emitted from the image projection unit toward an emission facet of the image projection unit, and a second folding mirror for reflecting the laser light toward the transmission type screen, said folding mirrors being provided between the image projection unit and the transmission type screen; wherein a distance between the first folding mirror and the image projection unit is larger than a class 2 nominal ocular hazard distance of the image projection unit, and the laser light emission facet of the image projection unit faces the transmission type screen.

According to Claim 8 of the present invention, in the rear projection type display device defined in Claim 7, the class 2 nominal ocular hazard distance of the image projection unit is a distance L by which a light output power emitted from the projection lens with a solid angle of 38.4/(L×L) is 1 mW.

According to Claim 9 of the present invention, in the rear projection type display device defined in Claim 7, the laser light emission facet of the image projection unit faces an approximately vertical lower surface.

According to Claim 10 of the present invention, the rear projection type display device defined in Claim 7 further includes a structure surrounding an optical path between the image projection unit and the first folding mirror.

According to Claim 11 of the present invention, the rear projection type display device defined in Claim 9 further includes a structure surrounding an optical path between the image projection unit and the first folding mirror.

According to Claim 12 of the present invention, there is provided a rear projection type display device according to Claim 12 of the present invention comprising: a transmission type screen; an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a plane opposite to an observation plane of the transmission type screen to form an image of the one-dimensional or two-dimensional spatial light modulation element; and a restriction plate for restricting approach of a person to the laser light path, which is provided in the optical path of the laser light emitted from the image projection unit; wherein a distance between the restriction plate and the image projection unit is larger than a class 2 nominal ocular hazard distance of the image projection unit.

According to Claim 13 of the present invention, in the rear projection type display device defined in Claim 12, the class 2 nominal ocular hazard distance of the image projection unit is a distance L by which a light output power emitted from the projection lens with a solid angle of 38.4/(L×L) is 1 mW.

According to Claim 14 of the present invention, the image projection device defined in any of Claims 1 to 6 further includes a detection unit for detecting entering of an object within the class 2 nominal ocular hazard distance of the image projection unit.

According to Claim 15 of the present invention, the rear projection type display device defined in any of Claims 7 to 13 further includes a detection unit for detecting entering of an object within the class 2 nominal ocular hazard distance of the image projection unit.

According to Claim 16 of the present invention, there is provided an image projection device comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element, and the device further includes a visible light irradiation unit for irradiating noncoherent visible light from a position near a projection port to a space which is within an optical path emitted from the image projection device, and is apart from the image projection device by a distance larger than a class 2 nominal ocular hazard distance of the image projection device.

According to Claim 17 of the present invention, in the image projection device defined in Claim 16, the class 2 nominal ocular hazard distance of the image projection device is a distance L by which a light output power emitted from the projection lens with a solid angle of 38.4/(L×L) is less than 1 mW.

According to Claim 18 of the present invention, there is provided an image projection device comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element, and the device further includes an air blowing unit for blowing air from a position near a projection port to a space which is within an optical path emitted from the image projection device, and is apart from the image projection device by a distance larger than a class 2 nominal ocular hazard distance of the image projection device.

According to Claim 19 of the present invention, in the image projection device defined in Claim 18, the class 2 nominal ocular hazard distance of the image projection device is a distance L by which a light output power emitted from the projection lens to a solid angle of 38.4/(L×L) is less than 1 mW.

### EFFECTS OF THE INVENTION

According to Claim 1 of the present invention, there is provided an image projection device comprising: an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element; and n pieces of folding mirrors including an n-th folding mirror (n: an integer not less than 1) for reflecting the laser light emitted from the image projection unit toward the screen, said folding mirrors being provided between the image projection unit and the screen; wherein a distance between the n-th folding mirror and the image projection unit is larger than a class 2 nominal ocular hazard distance of the image projection unit. Therefore, when the image projection unit is observed from a position onto which the image is projected, observation is carried out from a position apart by a distance larger than the class 2 nominal ocular hazard distance, thereby enhancing the safety.

According to Claim 2 of the present invention, in the image projection device defined in Claim 1, the class 2 nominal ocular hazard distance of the image projection unit is a distance L by which a light output power emitted from the projection lens with a solid angle of 38.4/(L×L) is 1 mW. Therefore, when the image projection unit is observed from a position onto which the image is projected, observation is carried out from a position apart by a distance larger than the class 2 nominal ocular hazard distance, thereby enhancing the safety with a required minimum device scale.

According to Claim 3 of the present invention, the image projection device defined in Claim 1 further includes a frame surrounding an optical path between the image projection unit and the n-th folding mirror. Therefore, it becomes difficult for a person to observe the laser light with his head being put in a region where the laser light is dangerous to human eyes, thereby further enhancing the safety.

According to Claim 4 of the present invention, in the image projection device defined in Claim 1, at least one of the n pieces of folding mirrors has a convex shape. Therefore, the divergence angle of the projected light from the image projection unit can be increased, and thereby the energy of the laser light is reduced to a safety level at a short distance, resulting in further miniaturization of the device.

According to Claim 5 of the present invention, an image projection device comprising: an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element; and a restriction plate for restricting approach of a person to the laser light path, which is provided between the image projection unit and the screen; wherein a distance between the restriction plate and the image projection unit is larger than a class 2 nominal ocular hazard distance of the image projection unit. Therefore, approach of a person to the laser light path can be restricted, thereby enhancing the safety.

According to Claim 6 of the present invention, in the image projection device defined in Claim 5, the class 2 nominal ocular hazard distance of the image projection unit is a distance L by which a light output power emitted from the projection lens with a solid angle of 38.4/(L×L) is 1 mW. Therefore, approach of a person to the laser light source can be restricted, thereby enhancing the safety with a required minimum device scale.

According to Claim 7 of the present invention, there is provided a rear projection type display device comprising: a transmission type screen; an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a plane opposite to an observation plane of the transmission type screen to form an image of the one-dimensional or two-dimensional spatial light modulation element; and at least two folding mirrors including a first folding mirror for folding the laser light emitted from the image projection unit toward an emission facet of the image projection unit, and a second folding mirror for reflecting the laser light toward the transmission type screen, said folding mirrors being provided between the image projection unit and the transmission type screen; wherein a distance between the first folding mirror and the image projection unit is larger than a class 2 nominal ocular hazard distance of the image projection unit, and the laser light emission facet of the image projection unit faces the transmission type screen. Therefore, by folding the optical path in the casing, observation within the class 2 nominal ocular hazard distance becomes difficult even when the screen is broken and the inside of the casing is observable, thereby enhancing the safety.

According to Claim 8 of the present invention, in the rear projection type display device defined in Claim 7, the class 2 nominal ocular hazard distance of the image projection unit is a distance L by which a light output power emitted from the projection lens with a solid angle of 38.4/(L×L) is 1 mW. Therefore, by folding the optical path in the casing, observation within the class 2 nominal ocular hazard distance becomes difficult even when the screen is broken and the inside of the casing is observable, thereby enhancing the safety with a required minimum device scale.

According to Claim 9 of the present invention, in the rear projection type display device defined in Claim 7, the laser light emission facet of the image projection unit faces an approximately vertical lower surface. Therefore, even when the screen is broken and the inside of the casing is observable, observation within the class 2 nominal ocular hazard distance becomes more difficult, thereby further enhancing the safety.

According to Claim 10 of the present invention, the rear projection type display device defined in Claim 7 further includes a structure surrounding an optical path between the image projection unit and the first folding mirror. Therefore, even when the screen is broken and the inside of the casing is observable, it is more difficult for a person to observe the laser light with his head being put in an area where the laser light is dangerous to human eyes, thereby further enhancing the safety.

According to Claim 11 of the present invention, the rear projection type display device defined in Claim 9 further includes a structure surrounding an optical path between the image projection unit and the first folding mirror. Therefore, even when the screen is broken and the inside of the casing is observable, it becomes more difficult for a person to observe the laser light with his head being put in an area where the laser light is dangerous to human eyes, thereby further enhancing the safety.

According to Claim 12 of the present invention, there is provided a rear projection type display device according to Claim 12 of the present invention comprising: a transmission type screen; an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a plane opposite to an observation plane of the transmission type screen to form an image of the one-dimensional or two-dimensional spatial light modulation element; and a restriction plate for restricting approach of a person to the laser light path, which is provided in the optical path of the laser light emitted from the image projection unit; wherein a distance between the restriction plate and the image projection unit is larger than a class 2 nominal ocular hazard distance of the image projection unit. Therefore, even when the screen is broken and the inside of the casing is observable, the safety can be enhanced by restricting approach of a person.

According to Claim 13 of the present invention, in the rear projection type display device defined in Claim 12, the class 2 nominal ocular hazard distance of the image projection unit is a distance L by which a light output power emitted from the projection lens with a solid angle of 38.4/(L×L) is 1 mW. Therefore, even when the screen is broken and the inside of the casing is observable, the safety can be enhanced with a required minimum device scale by restricting approach of a person.

According to Claim 14 of the present invention, the image projection device defined in any of Claims 1 to 6 further includes a detection unit for detecting entering of an object within the class 2 nominal ocular hazard distance of the image projection unit. Therefore, the laser light output is controlled against entering of a person in an area where the safety of his eyes cannot be ensured even by an avoidance behavior of human being without controlling the laser light output against entering of a person in an area where the safety of his eyes is ensured by an avoidance behavior, whereby a significant variation in the brightness of the image is avoided, and the safety is enhanced.

According to Claim 15 of the present invention, the rear projection type display device defined in any of Claims 7 to 13 further includes a detection unit for detecting entering of an object within the class 2 nominal ocular hazard distance of the image projection unit. Therefore, the laser light output is controlled against entering of a person in an area where the safety of his eyes cannot be ensured even by an avoidance behavior of human being without controlling the laser light output against entering of a person in an area where the safety of his eyes is ensured by an avoidance behavior, whereby a significant variation in the brightness of the image is avoided, and the safety is enhanced.

According to Claim 16 of the present invention, there is provided an image projection device comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element, and the device further includes a visible light irradiation unit for irradiating noncoherent visible light from a position near a projection port to a space which is within an optical path emitted from the image projection device, and is apart from the image projection device by a distance larger than a class 2 nominal ocular hazard distance of the image projection device. Therefore, even when a person tries to observe the laser light within an area where the laser light is dangerous to human eyes, it becomes difficult for the person to open his eyes due to the irradiated visible light, whereby the safety is further enhanced, and further miniaturization of the device is realized.

According to Claim 17 of the present invention, in the image projection device defined in Claim 16, the class 2 nominal ocular hazard distance of the image projection device is a distance L by which a light output power emitted from the projection lens with a solid angle of 38.4/(L×L) is less than 1 mW. Therefore, even when a person tries to observe the laser light within an area where the laser light is dangerous to human eyes, it becomes difficult for the person to open his eyes due to the irradiated visible light, whereby the safety is further enhanced, and further miniaturization of the device is realized.

According to Claim 18 of the present invention, there is provided an image projection device comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element, and the device further includes an air blowing unit for blowing air from a position near a projection port to a space which is within an optical path emitted from the image projection device, and is apart from the image projection device by a distance larger than a class 2 nominal ocular hazard distance of the image projection device. Therefore, even when a person tries to observe the laser light within an area where the laser light is dangerous to human eyes, it becomes difficult for the person to open his eyes due to the air blown from the air blowing unit, whereby the safety is further enhanced, and further miniaturization of the device is realized.

According to Claim 19 of the present invention, in the image projection device defined in Claim 18, the class 2 nominal ocular hazard distance of the image projection device is a distance L by which a light output power emitted from the projection lens with a solid angle of 38.4/(L×L) is less than 1 mW. Therefore, even when a person tries to observe the laser light within an area where the laser light is dangerous to human eyes, it becomes difficult for the person to open his eyes due to the air blown from the air blowing unit, whereby the safety is further enhanced, and further miniaturization of the device is realized.

### BRIEF DESCRIPTION OF THE DRAWINGS

FIG. 1 is a configuration diagram of an image projection device according to a first embodiment of the present invention.

FIG. 2 is a configuration diagram of an image projection means using a two-dimensional spatial light modulation element.

FIG. 3 is a configuration diagram of an image projection means using a one-dimensional spatial light modulation element.

FIG. 4 is a diagram illustrating an image projection device according to the first embodiment which is provided with an optical switch.

FIG. 5 is a diagram illustrating an image projection device according to the first embodiment wherein a first folding mirror has a convex shape.

FIG. 6 is a configuration diagram of an image projection device according to a second embodiment of the present invention.

FIG. 7 is a configuration diagram of a rear projection type display device according to a third embodiment of the present invention.

FIG. 8 is a diagram illustrating a rear projection type display device according to the third embodiment which is provided with an optical switch.

FIG. 9 is a diagram illustrating a rear projection type display device according to the third embodiment wherein a laser light emission facet of an image projection means is turned to an approximately vertical lower surface.

FIG. 10 is a diagram illustrating a rear projection type display device according to the third embodiment wherein an image projection means is provided with a structure.

FIG. 11 is a configuration diagram of a rear projection type display device according to a fourth embodiment.

FIG. 12 is a configuration diagram of an image projection device according to a fifth embodiment.

FIG. 13 is a configuration diagram of an image projection device according to a sixth embodiment.

### DESCRIPTION OF REFERENCE NUMERALS

100,400,500,600,1200,1300 . . . image projection device
101,107 . . . image projection means
102,502,707 . . . first folding mirror
103,708 . . . second folding mirror
104,709 . . . projected light
105,711 . . . casing
106 . . . holding frame
107,710 . . . screen
201 . . . blue laser
202 . . . red laser
203 . . . green laser
215 . . . projection lens
219a to 219c . . . rod integrator
221a to 221c . . . lens
222a to 222c . . . two-dimensional spatial light modulation element
223 . . . color composition prism
301 . . . laser light source
302,304 . . . lens
303 . . . one-dimensional spatial light modulation element
305 . . . scanning means
306 . . . laser light
401,801 . . . optical switch
601,1112 . . . restriction plate
700,800,900,1000,1100 . . . rear projection type display device
1001 . . . structure
1201a to 1201h . . . LED
1301 . . . fan

### BEST MODE TO EXECUTE THE INVENTION

Hereinafter, embodiments of the present invention will be described with reference to the drawings.

### Embodiment 1

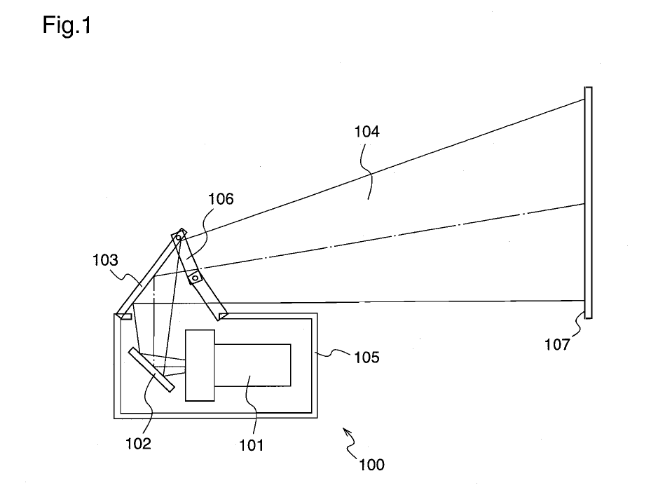

FIG. 1 is a configuration diagram of an image projection device 100 according to a first embodiment of the present invention.

In FIG. 1, the image projection device 100 comprises an image projection means 101 for projecting laser light, a first folding mirror 102 for initially folding the laser light emitted from the image projection means 101, a second folding mirror 103 for reflecting the laser light emitted from a projection lens onto a screen through the first folding mirror 102, a foldable holding frame 106, and a casing 105.

The image projection means 101 comprises, preferably, a laser light source, a two-dimensional light modulation element such as a liquid crystal panel or a micromirror array, and a projection lens. Alternatively, the image projection means 101 may comprise a laser light source, a one-dimensional light modulation element, a condenser lens, and a light scanning element.

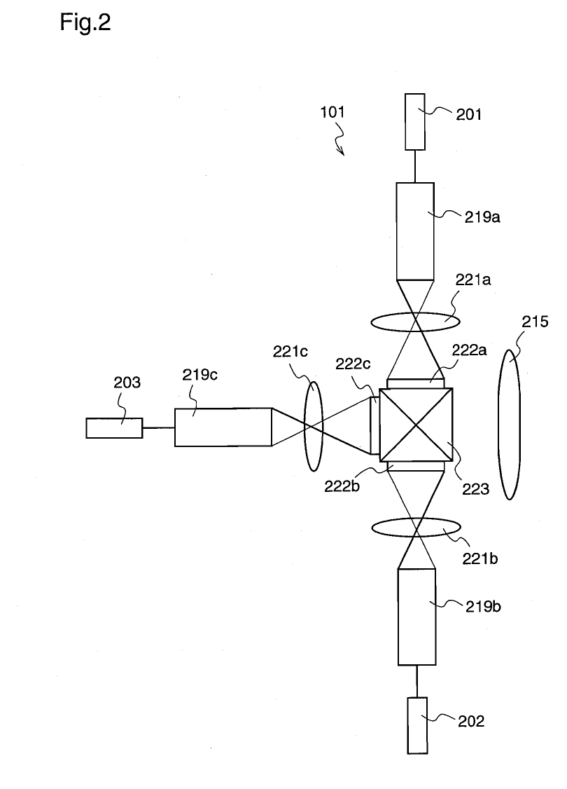

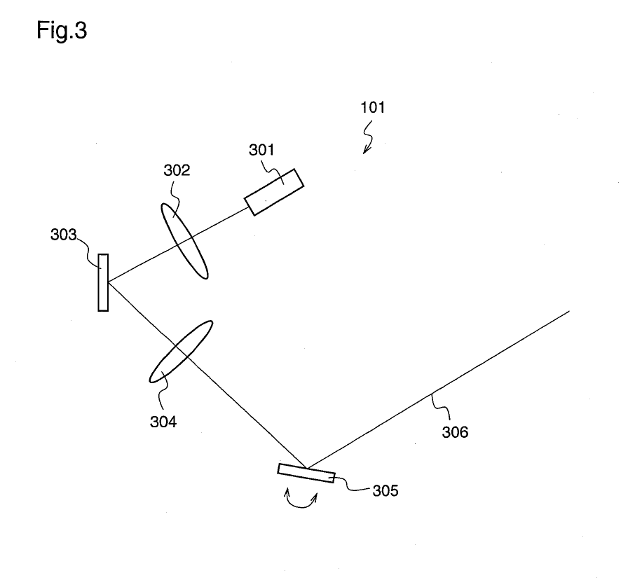

Next, the image projection means 101 which performs spatial light modulation by using a one-dimensional or two-dimensional spatial light modulation element will be described with reference to FIGS. 2 and 3.

FIG. 2 is a diagram illustrating the construction of the image projection means 101 which performs spatial light modulation by a two-dimensional spatial light modulation element.

With reference to FIG. 2, the image projection means 101 comprises a blue laser 201, a red laser 202, a green laser 203, rod integrators 219a to 219c, lenses 221a to 221c, spatial light modulation elements 222a to 222c, a color composition prism 223, and a projection lens 215.

Semiconductor lasers are preferably used as the blue laser 201 and the red laser 202, and a solid laser utilizing second-harmonic generation is preferably used as the green laser 203. The rod integrators 219a to 219c are formed of rectangular solid glass members. The spatial light modulation elements 222a to 222c are two-dimensional spatial light modulation elements, and transparent liquid crystal panels are used in this first embodiment. The color composition prism 223 reflects the laser light emitted from the blue laser 201 and the laser light emitted from the red laser 202 and transmits the laser light emitted from the green laser 203, and combines the blue, red, green laser lights.

Since the effect the laser light emitted from the blue laser 201 receives is of the same kind as the effect the laser lights emitted from the red laser 202 and the green laser 203 receive, only the laser light emitted from the blue laser 203 will be described with reference to FIG. 2 while descriptions for other lasers will be omitted. The laser light emitted from the blue laser 201 is incident on the rod integrator 219a. The laser light incident on the rod integrator 219a repeats reflection in the rod integrator 219a, whereby uniform distribution of light quantity is obtained at an emission facet of the rod integrator. Since the divergent laser light is irradiated to the spatial light modulation element 222a from the rod integrators 219a through the lens 221a, uniform illumination light can be obtained. The laser light modulated by the spatial light modulation element 222a is transmitted through the color composition prism 223 and the projection lens 215 to be focused on a screen 107.

FIG. 3 is a diagram illustrating the construction of the image projection means 101 which performs spatial light modulation by using a one-dimensional spatial light modulation element.

With reference to FIG. 3, the image projection means 101 comprises a laser light source 301, a lens 302, a one-dimensional spatial light modulation element 303, lens 304, and a scanning means 305.

Further, the one-dimensional spatial light modulation element 303 is obtained by linearly arranging light modulation elements in the vertical direction, and a galvanometer mirror is used as the scanning means 305.

Laser light emitted from the laser light source 301 is diverged by the lens 302, and the divergent laser light is irradiated to the one-dimensional spatial light modulation element 303. The laser light modulated by the one-dimensional spatial light modulation element 303 is focused on a screen (not shown) by the lens 304. On the screen, an image of the one-dimensional spatial light modulation element 303 in the vertical direction is scanned in parallel, thereby obtaining a two-dimensional image.

As described above, the image projection means 101 in the image projection device according to the first embodiment enlarges and projects the light modulated by the one-dimensional or two-dimensional spatial light modulation element, by using the projection lens. Since the laser light output is weakened with distance from the image projection means 101, the image projection device can be constituted such that a person can observe the laser light only from a safe distance.

Further, as described above, in the image projection device utilizing divergent light, the upper-limit laser light output that can ensure the safety by avoidance behavior of eyes even when collimated laser light enters into the eye, is 1 mW. It may be considered that the pupil diameter is about 7 mm although it is influenced by individual differences and surrounding brightness.

Accordingly, assuming that the distance from the projection lens of the image projection means to the pupil is L(mm), a solid angle formed by the pupil with respect to the projection lens is 38.4/(L×L), and therefore, if the laser light power that is emitted from the projection lens with that solid angle is less than 1 mW, the safety is secured.

In this first embodiment, the distance from the image projection means 101 to the second folding mirror 103 is set larger than the distance L by which the light output power emitted from the projection lens of the image projection means 101 with the solid angle of 38.4/(L×L) is 1 mW. That is, this distance is larger than the class 2 nominal ocular hazard distance with which the safety can be ensured by avoidance behaviors including blinking reflex when a human being sees bright light. Therefore, when a person observes the image projection device 100 from a position onto which the image is projected, this observation is carried out from a position apart by a distance larger than the class 2 nominal ocular hazard distance, whereby the safety can be enhanced with the required minimum device scale. Further, as shown in FIG. 1, the foldable holding frame 106 for holding the second folding mirror 103 at a predetermined angle is provided, and further, the casing 105 and the holding frame 106 are combined to provide a frame which surrounds the optical path between the image projection means 101 and the second folding mirror 103. So, even when a person comes closer to the second folding mirror 103 from the projection light 104, it is difficult for the person to observe the laser light with his head being inserted between the folding mirror 103 and the image projection means 101, considering from the size of a general image projection device such as a general front projector, and therefore, the person observes the laser light at a position farther than the folding mirror 103, and at this time, damage to his eye can be avoided by an avoidance behavior of the person. Further, when the image projection device is not used, the holding frame 106 is folded so that the folding mirror 103 contacts the casing 105. Furthermore, insertion of a human head becomes more difficult by making the holding frame 106 have a size that prevents insertion of the head, thereby further enhancing the safety.

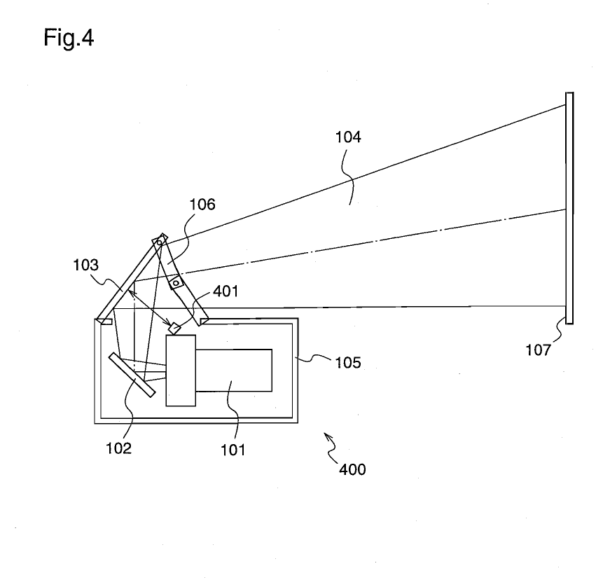

Furthermore, an optical switch 401 which emits light and again receives the light that is reflected by the second folding mirror 103 may be provided as a detection means in the casing 105 as shown in the image projection device 400 of FIG. 4. Thereby, when an object enters inside the folding mirror 103, the light emitted from the optical switch 401 is not reflected by the folding mirror 103 and is not received, and thus entering of the object can be detected. Further, the optical switch 401 reduces the laser output when it detects entering of an object, thereby further enhancing the safety.

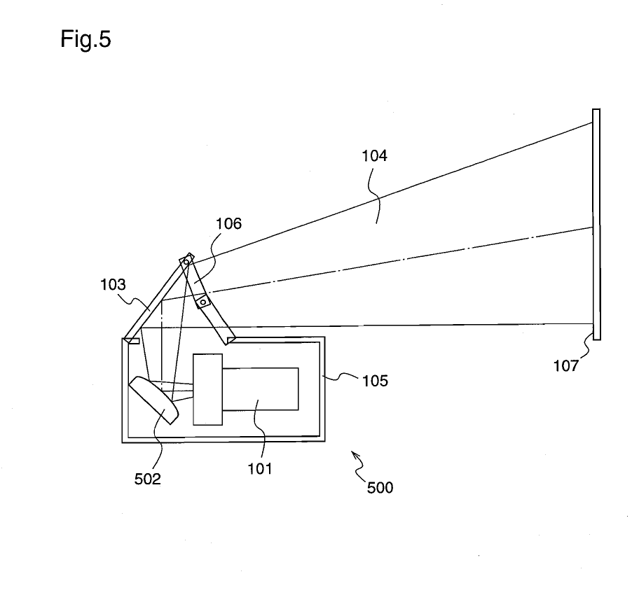

The first folding mirror of the image projection device according to the first embodiment may be replaced with a convex-shaped first folding mirror 502 of an image projection device 500 shown in FIG. 5. Thereby, since the divergence angle of the projected light from the projection lens can be increased, the energy of the laser light is reduced to a safe level at a short distance, resulting in further miniaturization of the device.

As described above, the image projection device according to the first embodiment of the present invention is provided with the image projection means 101 which comprises the laser light source (301, or 201 to 203), the one-dimensional or two-dimensional spatial light modulation electrode (303, or 222a to 222c) for spatially modulating the laser light emitted from the laser light source, and the projection lens for projecting the laser light that is spatially modulated by the one-dimensional or two-dimensional spatial light modulation element onto the screen 107 to form an image of the one-dimensional or two-dimensional spatial light modulation element, the first folding mirror 102 for initially folding the laser light emitted from the image projection means 101, which mirror 102 is provided between the image projection means 101 and the screen 107, and the second folding mirror 103 for reflecting the laser light emitted from the image projection means 101 onto the screen 107 through the first folding mirror 102, wherein the distance between the second folding mirror 103 and the projection lens is larger than the distance L by which the power of the laser light emitted from the projection lens with the solid angle of 38.4/(L×L) is 1 mW. Therefore, when a person observes the image projection device from a position onto which the image is projected, the person observes the laser light less than 1 mW, i.e., this observation is carried out from a position apart by a distance larger than the class 2 nominal ocular hazard distance, whereby the safety can be enhanced with the required minimum device scale.

Furthermore, since the holding frame 106 and the casing 105 are provided so as to surround the optical path between the second folding mirror 103 and the image projection means, it becomes difficult for a person to observe the laser light with his head being inserted in a region where the laser light is dangerous for human eye, thereby further enhancing the safety.

In this first embodiment, in order to make it difficult to put a head between the second folding mirror 103 and the image projection means 101, the distance from the image projection means 101 to the second folding mirror 103 is set larger than the distance L by which the light output power emitted from the projection lens of the image projection means 101 with the solid angle of 38.4/(L×L) is 1 mW. However, when a space in which a head can be inserted is made between the image projection means 101 and the folding mirror 103, one or plural folding mirrors may be added between them to make such insertion of a head difficult, or a frame surrounding the space between the image projection means 101 and the folding mirror 103 may be additionally provided.

Further, while in this first embodiment the first and second folding mirrors are provided, the number of the folding mirrors is not particularly restricted, and n (n: integer not less than 1) pieces of folding mirrors may be provided.

Furthermore, while in this first embodiment the first folding mirror has a convex shape, the present invention is not restricted thereto, and any one or some of the n pieces of folding mirrors may have a convex shape.

### Embodiment 2

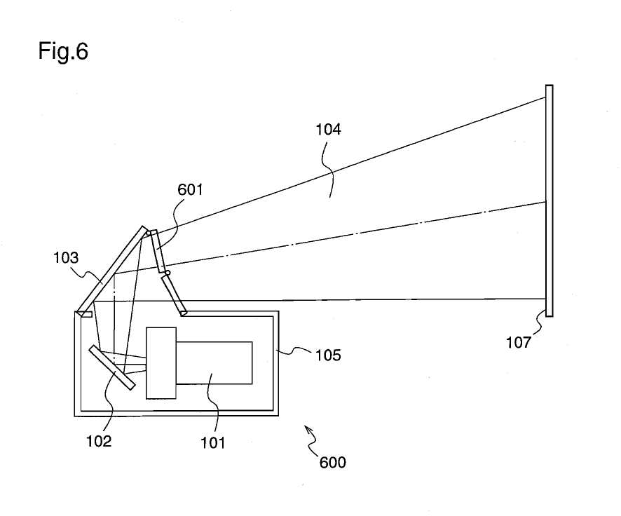

FIG. 6 is a configuration diagram of an image projection device according to a second embodiment of the present invention, and the same elements as those shown in FIG. 1 are given the same reference numerals to omit the description thereof. Further, in this second embodiment, the image projection means 101 adopts a one-dimensional or two-dimensional spatial light modulation element, and has the same construction as that shown in FIG. 2 or 3, and therefore, repeated description is not necessary.

The image projection device 600 according to the second embodiment is different from the first embodiment in that it is provided with a restriction plate 601 instead of the holding frame 106 of the first embodiment.

In FIG. 6, the restriction plate 601 preferably comprises a transparent acrylic plate having a high transmissivity to projected light 104, and is larger than a sectional area of beam of the projected light 104. Further, the restriction plate 601 holds the second folding mirror at a predetermined angle. Like the protection frame 106 of the first embodiment, the restriction plate 601 is foldable, and the casing 105 and the restriction plate 601 are combined to provide a frame which surrounds the optical path between the image projection means 101 and the second folding mirror 103. When the image projection device is not used, the restriction plate 601 is folded to make the folding mirror 103 contact the casing 105.

A distance between the restriction plate 601 and the image projection means 101 is set larger than the distance L by which the light output power emitted from the projection lens of the image projection means 101 with the solid angle of 38.4/(L×L) is 1 mW, as described for the first embodiment. That is, this is a distance larger than the class 2 nominal ocular hazard distance by which the safety is ensured by avoidance behaviors including blinking reflex when a human being sees bright light. Therefore, when a person observes the image projection device 100 from a position onto which the image is projected, this observation is carried out from a position apart by a distance larger than the class 2 nominal ocular hazard distance, and thus the safety can be enhanced with the required minimum device scale. Further, even when a person comes closer to the image projection means 101 from the projected light 104, since the restriction plate 601 is provided, it is difficult for the person to observe the laser light in an area where the laser light is dangerous to human eye. So, the person observes the laser light at a position apart more than the class 2 nominal ocular hazard distance, and then damage to his eye is avoided by an avoidance behavior of the person.

A sensor (not shown) for detecting breaking or displacement of the restriction plate 601 may be provided to reduce the laser light output. In this case, for example, the restriction plate may be provided with an electrode as a sensor, and when the restriction plate is broken, i.e., when the electrode becomes nonconductive due to the breaking, it is detected that the restriction plate is broken. Alternatively, the restriction plate 601 may be vibrated at a constant frequency using a piezoactuator, and it is detected that the restriction plate is broken when the vibration frequency or amplitude changes due to breaking or contact of the restriction plate.

Further, the restriction plate may be constituted in the protection frame 106 described for the first embodiment. Thereby, even when the restriction plate is broken, the protection frame 106 makes it difficult to observe the laser light with a head being inserted between the position where the restriction plate was provided and the image projection means 101, and therefore, damage to the eye can be avoided by an avoidance behavior of human being at this time.

Further, the first folding mirror 102 may be replaced with the convex-shaped first folding mirror 502 shown in FIG. 5, and thereby the divergence angle of the projected light from the projection lens can be increased, and the energy of the laser light is reduced to a safety level at a short distance, resulting in further miniaturization of the device.

As described above, the image projection device according to the second embodiment of the present invention is provided with the image projection means 101 which comprises the laser light source (301, or 201 to 203), the one-dimensional or two-dimensional spatial light modulation electrode (303, or 222a to 222c) for spatially modulating the laser light emitted from the laser light source, and the projection lens for projecting the laser light that is spatially modulated by the one-dimensional or two-dimensional spatial light modulation element onto the screen 107 to form an image of the one-dimensional or two-dimensional spatial light modulation element, and the restriction plate 601 for restricting approach of a person to the laser light path, which is disposed between the image projection means 101 and the screen 107, wherein the distance between the restriction plate 601 and the image projection means 101 is larger than the distance L by which the light output power emitted from the projection lens with the solid angle of 38.4/(L×L) is 1 mW. Therefore, when a person observes the image projection device from a position onto which the image is projected, the person observes the laser light less than 1 mW, and further, approach of the person to the laser light path is restricted by the restriction plate 601, whereby the safety can be enhanced with the required minimum device scale.

Further, since the restriction plate is provided with the detection means, even when the restriction plate is broken or moved, the laser output is reduced by the detection means, thereby further enhancing the safety.

Further, since the restriction plate is constituted in the holding frame, even when the restriction plate is broken, a physically safe distance can be ensured, thereby further enhancing the safety.

While in this second embodiment two folding mirrors, i.e., the first and second folding mirrors, are provided, the number of the folding mirrors is not restricted thereto, and n (n: integer not less than 1) pieces of folding mirrors may be provided.

Further, the restriction plate and the casing may be provided so as to surround the optical path between the image projection means and the restriction plate, without using the folding mirrors.

Further, while in this second embodiment the first folding mirror has a convex shape, the present invention is not restricted thereto, and any one or some of the n pieces of folding mirrors may have a convex shape.

### Embodiment 3

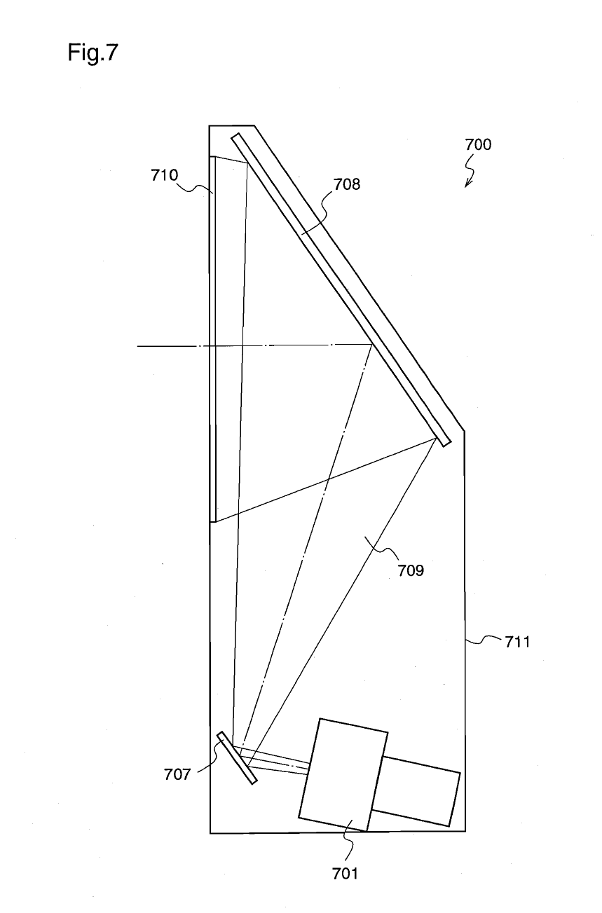

FIG. 7 is a configuration diagram of a rear projection type display device according to a third embodiment of the present invention.

With reference to FIG. 7, the rear projection type display device 700 of the third embodiment has a laser light emitting facet facing a screen 710, and comprises an image projection means 701 for projecting laser light, a first folding mirror 707 for folding the laser light emitted from the image projection means 701 toward the image projection means 701, a second folding mirror 708 for reflecting the laser light reflected by the first folding mirror 707, toward the screen 710 to emit the laser light from the image projection means 701 to the screen 710, the screen 710 for displaying an image by the laser light from the image projection means 701, and a casing 711 containing these elements.

The image projection means 701 according to the third embodiment preferably comprises a laser light source, a two-dimensional light modulation element such as a liquid crystal panel or a micromirror array, and a projection lens, like the image projection means 101 of the first embodiment. Alternatively, the image projection means 701 may comprise a laser light source, a one-dimensional light modulation element, a condenser lens, and a light scanning element. Since the construction of the image projection means 701 using the one-dimensional or two-dimensional spatial light modulation element is identical to that of the image projection means 101 described with reference to FIG. 2 or 3, repeated description is not necessary.

In this third embodiment, the screen 710 is a transmission type screen. The laser light emitted from the image projection means 701 is projected onto a plane opposite to an observation plane of the transmission type screen 710, and the projected light 709 is scattered by the transmission type screen 710.

Further, since the image projection means 701 in the rear projection type display device of the third embodiment enlarges and projects the light modulated by the one-dimensional or two-dimensional spatial light modulation element by using the projection lens, like the image projection means 101 of the first embodiment, the laser light output is weakened with distance from the image projection means 701, and thereby the rear projection type display device can be constructed such that a person can observe the laser light only from a safety distance.

In this third embodiment, the distance from the image projection means 701 to the first folding mirror 707 is set larger than the distance L by which the light output power emitted from the projection lens of the image projection means 701 with the solid angle of 38.4/(L×L) is 1 mW. That is, this distance is larger than the class 2 nominal ocular hazard distance by which the safety can be ensured by avoidance behaviors including blinking reflex when a human being sees bright light. Therefore, when the screen 710 is broken and the inside of the casing 711 is observable, it is possible for a person to observe the projected light 709 after the first folding mirror 707 by inserting his head inside the casing 711 through the broken screen 701, but it is difficult to insert his head between the first folding mirror 707 and the image projection means 101. So, it is possible to prevent that a person would observe the laser light at a position within the distance that can ensure the safety by an avoidance behavior of eyes.

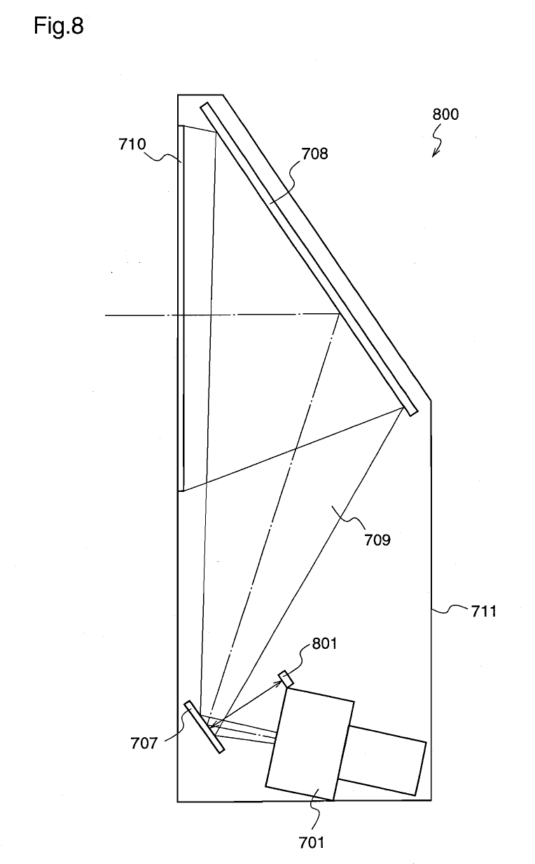

Further, as in a rear projection type display device 800 shown in FIG. 8, an optical switch 801 which emits light and again receives the light that is reflected at the first folding mirror 707 may be provided in the casing 711 as a detection means. Thereby, when an object enters inside the first folding mirror 707, the light emitted from the optical switch 801 is not reflected by the first folding mirror 707 and is not received by the optical switch 801, thereby detecting entering of the object. Further, the optical switch 801 reduces the laser output when it detects entering of the object, thereby further enhancing the safety.

As described above, the rear projection type display device 700 according to the third embodiment of the present invention is provided with the image projection means 701 which comprises the transmission type screen 710, the laser light source (301, or 201 to 203), the one-dimensional or two-dimensional spatial light modulation electrode (303, or 222a to 222c) for spatially modulating the laser light emitted from the laser light source, and the projection lens for projecting the laser light that is spatially modulated by the one-dimensional or two-dimensional spatial light modulation element onto the plane opposite to the observation plane of the transmission type screen 710 to form an image of the one-dimensional or two-dimensional spatial light modulation element, and at least two folding mirrors including the first folding mirror 102 for folding the laser light emitted from the image projection means 701 toward the emission facet of the image projection means, which is disposed between the image projection means 701 and the transmission type screen 710, and the second folding mirror 708 for reflecting the laser light onto the transmission type screen 710, wherein the distance between the first folding mirror 707 and the image projection means 701 is larger than the distance L by which the laser light emitted from the projection lens with the solid angle of 38.4/(L×L) is 1 mW, and the laser light emission facet of the image projection means 701 facts the screen 710. Therefore, when the screen 710 is broken and the inside of the casing 711 is observable, it is possible for a person to observe the projected light 709 after the first folding mirror 707 by inserting his head inside the casing 711 through the broken screen 701, but it is difficult to insert his head between the first folding mirror 707 and the image projection means 701. So, it is possible to prevent that a person would observe the laser light at a position within the distance that can ensure the safety by an avoidance behavior of eyes.

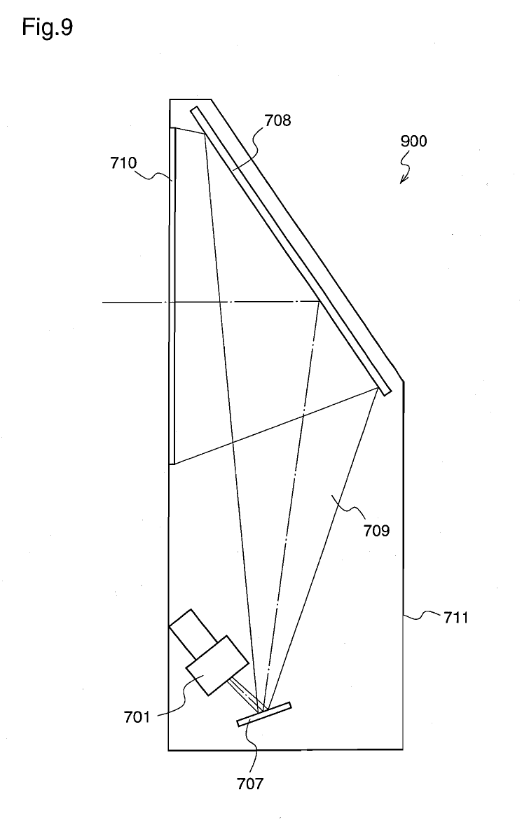

While in this third embodiment the laser light emission facet of the image projection means 701 faces the screen, the present invention is not restricted thereto. For example, as in a rear projection type display device 900 shown in FIG. 9, the image projection means 701 may be constituted so as to face an approximately vertical lower surface, and the distance between the image projection means 701 and the first folding mirror 707 is set larger than the distance L by which the light output power emitted from the projection lens with the solid angle of 38.4/(L×L) is 1 mW. Thereby, even when the screen 710 is broken and the inside of the casing 711 is observable, it becomes more difficult for a person to observe the laser light with his head being inserted between the first folding mirror 707 and the image projection means 701, and the safety is further enhanced.

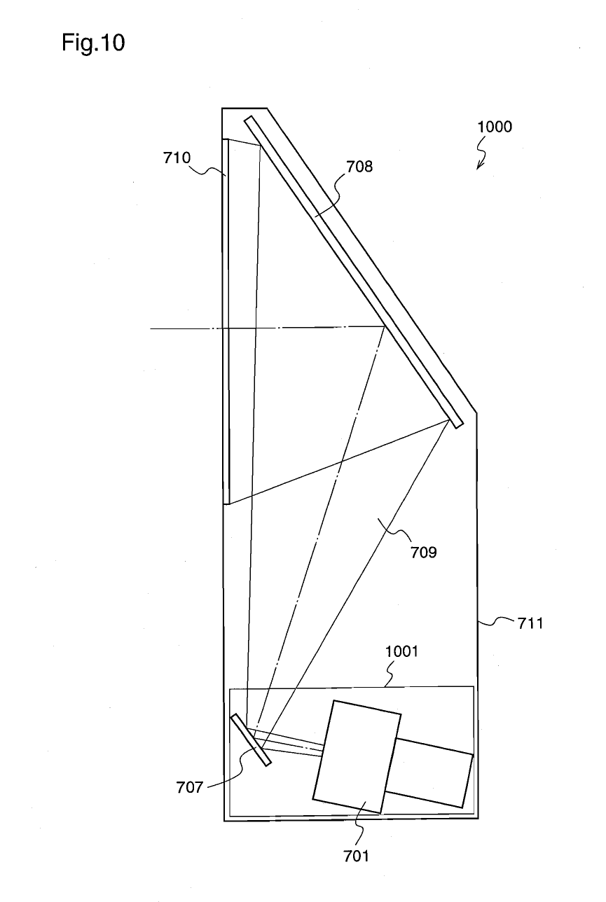

In this third embodiment, the distance between the image projection means 701 and the first folding mirror 707 is set larger than the distance L by which the laser light emitted from the projection lens with the solid angle of 38.4/(L×L) is 1 mW, thereby to ensure the safety. Furthermore, as shown in a rear projection type display device 1000 of FIG. 10, a structure 1001 may be provided so as to surround the optical path between the image projection means 701 and the first folding mirror 707. Thereby, even when the screen 710 is broken and the inside of the casing is observable, it becomes more difficult for a person to observe the laser light with his head being inserted between the first folding mirror 707 and the image projection means 701, and the safety is further enhanced. An upper portion of the structure 1001 is preferably formed of transparent acrylic so as to transmit the projected light 709 that is reflected by the first folding mirror 707.

### Embodiment 4

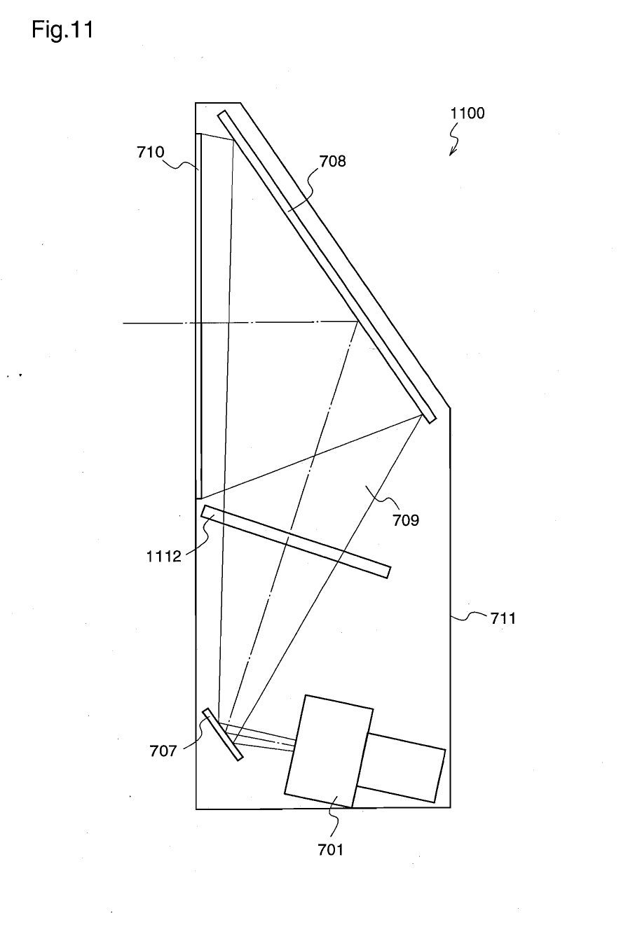

FIG. 11 is a configuration diagram illustrating a rear projection type display device according to a fourth embodiment of the present invention, wherein the same elements as those shown in FIG. 7 are given the same reference numerals to omit description thereof. Further, in this fourth embodiment, the image projection means 701 uses a one-dimensional or two-dimensional spatial light modulation element as in the third embodiment, and its construction is identical to the image projection means 101 shown in FIG. 2 or 3, and therefore, repeated description is not necessary.

The rear projection type display device 1100 according to the fourth embodiment is different from the rear projection type display device 700 according to the third embodiment in that a restriction plate 1112 is further provided.

In FIG. 11, the restriction plate preferably comprises a transparent acrylic plate having a high transmissivity to projected light 709, and is larger than a sectional area of beam of the projected light 709. Further, as described for the first embodiment, the distance between the restriction plate 1112 and the image projection means 701 is set larger than the distance L by which the light output power emitted from the projection lens from the image projection means 101 with the solid angle of 38.4/(L×L) is 1 mW. That is, this is a distance larger than the class 2 nominal ocular hazard distance by which the safety is ensured by avoidance behaviors including blinking reflex when a human being sees bright light. Therefore, when the screen 710 is broken and the inside of the casing 711 is observable, it is possible for a person to observe the projected light 709 after the first folding mirror 707 by inserting his head inside the casing 711 through the broken screen 701, but it is difficult to insert his head between the restriction plate 1112 and the image projection means 701. So, it is possible to prevent that a person would observe the laser light at a position within the distance that can ensure the safety by an avoidance behavior of eyes.

Further, a sensor (not shown) for detecting breaking or displacement of the restriction plate 1112 may be provided to reduce the laser light output. In this case, for example, the restriction plate 1112 may be provided with an electrode as a sensor, and when the restriction plate is broken, i.e., when the electrode becomes nonconductive due to the breaking, it is detected that the restriction plate is broken. Alternatively, the restriction plate 1112 may be vibrated at a constant frequency using a piezoactuator, and it is detected that the restriction plate is broken when the vibration frequency or amplitude changes due to breaking or contact of the restriction plate.

As described above, the rear projection type display device 1100 according to the fourth embodiment of the present invention is provided with the image projection means 701 which comprises the transmission type screen 710, the laser light source (301, or 201 to 203), the one-dimensional or two-dimensional spatial light modulation electrode (303, or 222a to 222c) for spatially modulating the laser light emitted from the laser light source, and the projection lens for projecting the laser light that is spatially modulated by the one-dimensional or two-dimensional spatial light modulation element onto the plane opposite to the observation plane of the transmission type screen 710 to form an image of the one-dimensional or two-dimensional spatial light modulation element, and the restriction plate 1112 for restricting approach of a person to the laser light path, which is disposed in the optical path of the laser light emitted from the image projection means 701, and the distance between the restriction plate 1112 and the image projection means 701 is set larger than the distance L by which the light output power emitted from the projection lens with the solid angle of 38.4/(L XL) is equal to 1 mW. Therefore, when the screen 710 is broken and the inside of the casing 711 is observable, it is possible for a person to observe the projected light 709 after the first folding mirror 707 by inserting his head inside the casing 711 through the broken screen 701, but it is difficult to insert his head between the restriction plate 1112 and the image projection means 701. So, it is possible to prevent that a person would observe the laser light at a position within the distance that can ensure the safety by an avoidance behavior of eyes.

Further, since the restriction plate 1112 is provided with the detection means, even when the restriction plate is broken or moved, the laser output is reduced by the detection means, whereby the safety is further enhanced.

While in this fourth embodiment two folding mirrors, i.e., the first folding mirror 707 and the second folding mirror 708, are used, the present invention is not restricted thereto. For example, only the second folding mirror 708 may be provided. In this case, the distance between the restriction plate 1112 and the image projection means 701 is set larger than the distance L by which the laser light emitted from the projection lens with the solid angle of 38.4/(L×L) is 1 mW, and the laser light emitted from the image projection means 101 is directly applied to the restriction plate 1112.

### Embodiment 5

An image projection device according to a fifth embodiment of the present invention emits visible light to secure a safety distance by an avoidance behavior of human eyes.

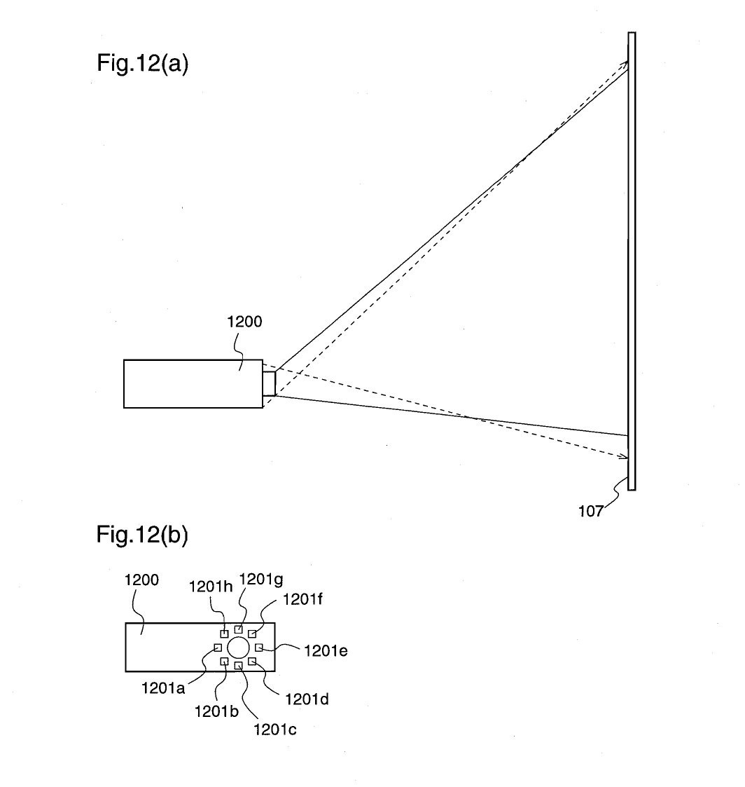

FIG. 12 is a diagram illustrating the image projection device according to the fifth embodiment.

In FIG. 12, the image projection device 1200 is provided with a laser light source, a one-dimensional or two-dimensional spatial light modulation element for spatially modulating the laser light emitted from the laser light source, and a projection lens for projecting the laser light spatially modulated by the one-dimensional or two-dimensional spatial light modulation element onto a screen to form an image of the one-dimensional or two-dimensional spatial light modulation element, as in the image projection means 101 or 701 according to any of the first to fourth embodiments, and the image projection device 1200 utilizes divergent light. Since these constituents are identical to those of the image projection means 101 shown in FIG. 2 or 3, repeated description is not necessary.

In this fifth embodiment, LED 1201a to 1201h are provided as visible light irradiation units in the vicinity of a projection port of the image projection device 1200, and noncoherent visible lights are emitted from the LED 1201a to 1201h toward the front end of the projection lens, i.e., in the projection direction.

Since the image projection device 1200 according to the fifth embodiment enlarges and projects the light modulated by the one-dimensional or two-dimensional spatial light modulation element by using the projection lens as in the first to fourth embodiments, the laser light output is weakened with distance from the image projection device 1200. Therefore, it is possible to constitute the image projection device such that a person can observe the laser light only from a safety distance.

In this fifth embodiment, the visible lights emitted from the LED 1201a to 1201h are focused in a space that is apart by a distance larger than the distance L by which the light output power emitted from the projection lens with the solid angle of 38.4/(L×L) is 1 mW. That is, this is a distance larger than the class 2 nominal ocular hazard distance by which safety is ensured by avoidance behaviors including blinking reflex when a human being sees bright light. Further, the intensity of the visible light may be set to such a level that, when a person approaches the projection lens, the person cannot view the projection lens in a space that is apart by a distance larger than the distance L by which the light output power emitted from the projection lens with the solid angle of 38.4/(L×L) is 1 mW.

Further, the LED 1201a to 1201h emit the visible lights from the periphery of the projection lens such that the lights once cross in front of the projection lens and then reach the periphery of the projected image on the screen.

As described above, the image projection device 1200 according to the fifth embodiment of the present invention is provided with the laser light source (301, or 201 to 203), the one-dimensional or two-dimensional spatial light modulation electrode (303, or 222a to 222c) for spatially modulating the laser light emitted from the laser light source, the projection lens for projecting the laser light that is spatially modulated by the one-dimensional or two-dimensional spatial light modulation element onto the screen 1202 to form an image of the one-dimensional or two-dimensional spatial light modulation element, and the visible light irradiation units 1201a to 1201h which emit noncoherent lights from a position in the vicinity of the projection port toward a space that is in the optical path emitted from the image projection device and is apart from the image projection device by a distance larger than the distance L by which the light output power emitted from the projection lens with the solid angle of 38.4/(L×L) is 1 mW. Therefore, even when a person tries to approach the image projection device from the position onto which the image is projected, the person cannot see the device due to the visible lights radiated from the LED 1201a to 1201h, and thus the person is prevented from observing the projection lens from a distance within the class 2 nominal ocular hazard distance, thereby providing a safe image projection device. Further, since observation of the projection lens at a short distance can be avoided without using a folding mirror and a casing, further miniaturization of the device can be realized.

It is needless to say that the visible light irradiation unit in the image projection device according to the fifth embodiment can be effectively combined with the image projection device according to any of the first to fourth embodiments.

Further, the visible light irradiation unit in the image projection device according to the fifth embodiment may adopt, as a noncoherent light source, a light source which excites a fluorescent substance with LED light, a halogen lamp, or a xenon lamp, as well as the directly emitting LED.

### Embodiment 6

An image projection device according to a sixth embodiment of the present invention blows air to secure a safe distance by an avoidance behavior of eyes.

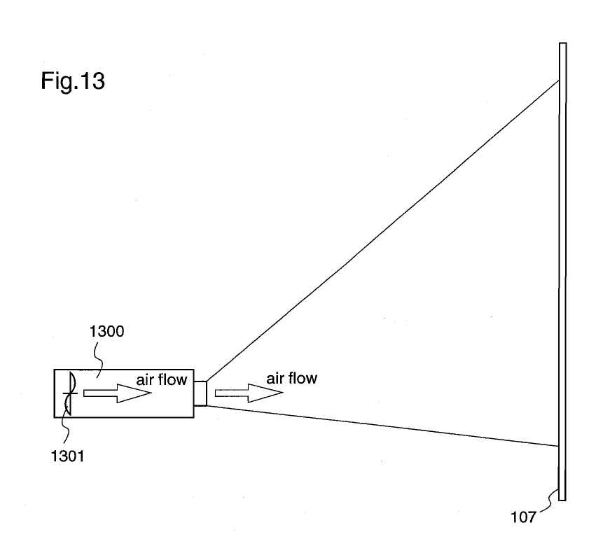

FIG. 13 is a diagram illustrating the image projection device according to the sixth embodiment.

In FIG. 13, the image projection device 1300 is provided with a laser light source, a one-dimensional or two-dimensional spatial light modulation element for spatially modulating the laser light emitted from the laser light source, and a projection lens for projecting the laser light spatially modulated by the one-dimensional or two-dimensional spatial light modulation element onto a screen to form an image of the one-dimensional or two-dimensional spatial light modulation element, as in the image projection means 101 or 701 according to any of the first to fourth embodiments, and the image projection device 1300 utilizes divergent light. Since these constituents are identical to those of the image projection means 101 shown in FIG. 2 or 3, repeated description is not necessary. Further, a fan 1301 is provided as an air blowing unit in the image projection device according to the sixth embodiment, and air is blown from the fan 1301 toward the front end of the projection lens, i.e., in the projection direction.

Since the image projection device 1300 enlarges and projects the light modulated by the one-dimensional or two-dimensional spatial light modulation element by using the projection lens as in the first to fourth embodiments, the laser light output is weakened with distance from the image projection device 1300, and therefore, it is possible to constitute the image projection device such that a person can observe the laser light only from a safety distance.

In this sixth embodiment, the air from the fan 1301 is blown to a space that is apart by a distance larger than the distance L by which the light output power emitted from the projection lens of the image projection device 1300 with the solid angle of 38.4/(L×L) is 1 mW. That is, this is a distance larger than the class 2 nominal ocular hazard distance by which the safety is ensured by avoidance behaviors including blinking reflex when a human being sees bright light. The intensity of the blown air may be set to such a level that, when a person approaches the image projection device, the person cannot see the projection lens in a space that is apart by a distance larger than the distance L by which the laser light emitted from the projection lens of the image projection device 1300 with the solid angle of 38.4/(L×L) is 1 mW.

The fan 1301 may be constituted so as to also perform cooling for the device by its air flow.

As described above, the image projection device 1300 according to the sixth embodiment of the present invention comprises the laser light source (301, or 201 to 203), the one-dimensional or two-dimensional spatial light modulation electrode (303, or 222a to 222c) for spatially modulating the laser light emitted from the laser light source, the projection lens for projecting the laser light that is spatially modulated by the one-dimensional or two-dimensional spatial light modulation element onto the screen to form an image of the one-dimensional or two-dimensional spatial light modulation element, and the air blowing unit 1301 for blowing air from a position near the projection port toward a space that is in the optical path emitted from the image projection device and is apart from the image projection device by a distance larger than the distance L by which the light output power emitted from the projection lens of the image projection device with the solid angle of 38.4/(LX L) is 1 mW. Therefore, even when a person tries to approach the image projection device from the position onto which the image is projected, the person cannot see the device due to the air blown from the fan 1301, and thus observation of the image projection device at a distance within the class 2 nominal ocular hazard distance is avoided, thereby providing a safe image projection device. Further, since observation of the projection lens at a short distance can be avoided without using a folding mirror and a casing, further miniaturization of the device can be realized.

It is needless to say that the air blowing unit of the image projection device according to the sixth embodiment can be effectively combined with the image projection devices according to the first to fourth embodiments.

### APPLICABILITY IN INDUSTRY

An image projection device and a rear projection type display device according to the present invention are useful as an image projection device and a rear projection type display device which are provided with a structure for preventing a person from observing laser light at a position within the class 2 nominal ocular hazard distance, thereby to enhance the safety.

1. An image projection device comprising:
an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element; and
n pieces of folding mirrors including an n-th folding mirror (n: an integer not less than 1) for reflecting the laser light emitted from the image projection unit toward the screen, said folding mirrors being provided between the image projection unit and the screen;
wherein a distance between the n-th folding mirror and the image projection unit is larger than a class 2 nominal ocular hazard distance of the image projection unit.

2. An image projection device as defined in claim 1 wherein the class 2 nominal ocular hazard distance of the image projection unit is a distance L by which a light output power emitted from the projection lens with a solid angle of 38.4/(L×L) is 1 mW.

3. An image projection device as defined in claim 1 further including a frame surrounding an optical path between the image projection unit and the n-th folding mirror.

4. An image projection device as defined in claim 1 wherein at least one of the n pieces of folding mirrors has a convex shape.

5. An image projection device comprising:
an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element; and
a restriction plate for restricting approach of a person to the laser light path, which is provided between the image projection unit and the screen;
wherein a distance between the restriction plate and the image projection unit is larger than a class 2 nominal ocular hazard distance of the image projection unit.

6. An image projection device as defined in claim 5 wherein the class 2 nominal ocular hazard distance of the image projection unit is a distance L by which a light output power emitted from the projection lens with a solid angle of 38.4/(L×L) is 1 mW.

7. A rear projection type display device comprising:
a transmission type screen;
an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a plane opposite to an observation plane of the transmission type screen to form an image of the one-dimensional or two-dimensional spatial light modulation element; and
at least two folding mirrors including a first folding mirror for folding the laser light emitted from the image projection unit toward an emission facet of the image projection unit, and a second folding mirror for reflecting the laser light toward the transmission type screen, said folding mirrors being provided between the image projection unit and the transmission type screen;
wherein a distance between the first folding mirror and the image projection unit is larger than a class 2 nominal ocular hazard distance of the image projection unit, and the laser light emission facet of the image projection unit faces the transmission type screen.

8. A rear projection type display device as defined in claim 7 wherein the class 2 nominal ocular hazard distance of the image projection unit is a distance L by which a light output power emitted from the projection lens with a solid angle of 38.4/(L×L) is 1 mW.

9. A rear projection type display device as defined in claim 7 wherein said laser light emission facet of the image projection unit faces an approximately vertical lower surface.

10. A rear projection type display device as defined in claim 7 further including a structure surrounding an optical path between the image projection unit and the first folding mirror.

11. A rear projection type display device as defined in claim 9 further including a structure surrounding an optical path between the image projection unit and the first folding mirror.

12. A rear projection type display device comprising:
a transmission type screen;
an image projection unit comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a plane opposite to an observation plane of the transmission type screen to form an image of the one-dimensional or two-dimensional spatial light modulation element; and
a restriction plate for restricting approach of a person to the laser light path, which is provided in the optical path of the laser light emitted from the image projection unit;
wherein a distance between the restriction plate and the image projection unit is larger than a class 2 nominal ocular hazard distance of the image projection unit.

13. A rear projection type display device as defined in claim 12 wherein the class 2 nominal ocular hazard distance of the image projection unit is a distance L by which a light output power emitted from the projection lens with a solid angle of 38.4/(L×L) is 1 mW.

14. An image projection device as defined in claim 1 further including a detection unit for detecting entering of an object within the class 2 nominal ocular hazard distance of the image projection unit.

15. A rear projection type display device as defined in claim 7 further including a detection unit for detecting entering of an object within the class 2 nominal ocular hazard distance of the image projection unit.

16. An image projection device comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element, said device further including:
a visible light irradiation unit for irradiating noncoherent visible light from a position near a projection port to a space which is within an optical path emitted from the image projection device and is apart from the image projection device by a distance larger than a class 2 nominal ocular hazard distance of the image projection device.

17. An image projection device as defined in claim 16 wherein the class 2 nominal ocular hazard distance of the image projection device is a distance L by which a light output power emitted from the projection lens with a solid angle of 38.4/(L×L) is less than 1 mW.

18. An image projection device comprising a laser light source for emitting laser light, one-dimensional or two-dimensional spatial light modulation element for spatially modulating the divergent laser light emitted from the laser light source, and a projection lens for projecting the laser light that is spatially modulated by the one-dimensional or two-dimensional light modulation element onto a screen to form an image of the one-dimensional or two-dimensional spatial light modulation element, said device further including:
an air blowing unit for blowing air from a position near a projection port to a space which is within an optical path emitted from the image projection device and is apart from the image projection device by a distance larger than a class 2 nominal ocular hazard distance of the image projection device.

19. An image projection device as defined in claim 18 wherein the class 2 nominal ocular hazard distance of the image projection device is a distance L by which a light output power emitted from the projection lens with a solid angle of 38.4/(L×L) is less than 1 mW.
